(19) United States
(12) Patent Application Publication
(10) Pub. No.: US 2013/0230714 A1
(43) Pub. Date: Sep. 5, 2013

(54) SYSTEM AND METHOD FOR LEATHER FORMING

(71) Applicant: Roy LIRAN, Tel Aviv (IL)

(72) Inventor: Roy LIRAN, Tel Aviv (IL)

(21) Appl. No.: 13/731,454

(22) Filed: Dec. 31, 2012

Related U.S. Application Data
(60) Provisional application No. 61/606,485, filed on Mar. 5, 2012.

(51) Int. Cl. B32B 37/10

(52) U.S. Cl. CPC B32B 37/1018
USPC 428/318.4; 156/285; 428/473; 428/414; 428/447

(57) ABSTRACT

A novel vacuum forming technique is disclosed whereby unique leather-plastic sandwich materials may be formed into arbitrary shapes using a molding technique having similarities to the vacuum thermoforming and leather molding processes. The leather itself may be softened before applying a vacuum forming step by means of soaking in warm water. The vacuum step removes the water thus hardening the material.

### BACKGROUND

1. Technical Field

Embodiments of the present invention relate generally to systems and methods for leather forming.

2. Description of Related Art

Current methods of leather forming generally require metallic or other massive forms and produce goods of some degree of remaining flexibility.

Hence, an improved method for leather forming is still a long felt need.

### BRIEF SUMMARY

An aspect of the invention provides for a leather-plastic sandwich article comprising layers of leather and plastic rigidly bonded and formed into a desired shape.

It is further within provision of the invention that the leather-plastic sandwich article be produced by a leather vacuum-forming technique comprising steps of
a. softening a largely planar piece of leather;
b. placing said leather over a rigid plastic form;
c. placing said form upon a vacuum backing plate;
d. placing a framework around the periphery of said leather;
e. drawing a vacuum between said leather and said plate;
f. removing said leather and plastic form from said vacuum plate;
g. bonding said plastic to said leather.

It is further within provision of the invention wherein said leather is softened by means selected from the group consisting of: soaking in warm water; chemical softening treatment; mechanical softening treatment.

It is further within provision of the invention wherein said leather is bonded to said plastic form by means of: epoxy; cyanoacrylate, collagen based adhesive, plant-based glues, polystyrene cement, synthetic monomer glues, synthetic polymer glues, rubber cement, silicones.

It is further within provision of the invention wherein said step of bonding said plastic to said leather is accomplished by placing glue between said plastic form and said leather before drawing said vacuum.

It is further within provision of the invention wherein said plastic form is itself formed by means of vacuum forming techniques.

It is further within provision of the invention wherein said plastic form comprises two plastic outer layers and a foam inner layer.

It is further within provision of the invention wherein said plastic form is produced by filling an interstitial space between two said plastic outer layers with expanding urethane foam.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates parts involved in the process of vacuum forming;

FIG. 2 illustrates parts involved in the process of vacuum forming according to one embodiment of the invention at an initial stage of the process;

FIG. 3 illustrates parts involved in the process of vacuum forming according to one embodiment of the invention at a subsequent stage of the process;

FIG. 4 illustrates parts involved in the process of vacuum forming according to one embodiment of the invention at a subsequent stage of the process;

FIG. 5 illustrates a side view of one stage of the process according to one embodiment of the invention.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for leather vacuum forming.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1, 5, or 10).

Thermoforming involves heating a plastic sheet to a pliable forming temperature, forming it to a desired shape by means of conforming it to a mold using pressure and/or vacuum, and trimming it to create a usable product. The sheet or film is generally heated to a sufficient temperature that may be stretched into or onto the mold whose form it adopts to plastic deformation, and subsequently cooled to a finished shape.

Thermoforming in general refers to the manufacturing of plastic components through vacuum and/or pressure forming processes. These processes generally involve heating an extruded sheet of plastic and either forming the sheet over a male mold or into a female mold. The thermoforming process enables production of parts with the same aesthetic properties as injection-molded parts at a fraction of the tooling expense involved in injection molding sheet.

The thermoplastic sheets used in thermoforming are generally heated to a softening point, stretched over or into a single-sided mold, and held in place while cooling and solidifying into the desired shape. The thermoplastic sheet is clamped into a holding device and heated, generally by an oven using either convection or radiant heat until it is softened. The sheet is then held horizontally over a mold and pressed into or stretched over the mold using vacuum pressure, air pressure, or mechanical force. The softened sheet conforms to the shape of the mold and is held in place until it cools.

Thermoforming is often used for food packaging, but has many applications from plastic toys to aircraft windscreens to cafeteria trays. Thin-gauge sheets are often used for rigid or disposable packaging, while thick-gauge sheets are typically used for cosmetic permanent surfaces on automobiles, shower enclosures, electronic equipment, etc.

A small tabletop or lab size machine may in principle be used to heat small cut sections of plastic sheet and stretch it over a mold using vacuum. This method is often used for samples and prototypes. Large production machines can be used to heat, form and trim in a continuous high-speed process.

As mentioned above, there are different methods of forcing the thermoplastic sheet to conform to the mold. These types of thermoforming include thin gauge thermoforming, thick gauge thermoforming, vacuum thermoforming, pressure forming, and mechanical forming.

Thin-gauge thermoforming is used in manufacture of disposable cups, containers, lids, trays, blisters, clamshells, and other products for food, medical, and general retail industries. Thick-gauge thermoforming is used for vehicle door and dash panels, refrigerator liners, utility vehicle beds, and plastic pallets.

Vacuum forming as described above uses a vacuum formed between the mold cavity and the thermoplastic sheet. The vacuum forces the sheet to conform to the mold, forming the part shape.

Pressure forming adds to the vacuum underneath the sheet, positive air pressure above the sheet to help force it onto the mold. This additional force allows the forming of thicker sheets and creating finer details, textures, undercuts, and sharp corners.

Mechanical forming uses mechanical force into or around the mold by direct contact. Generally a core or male plug will push the sheet into the mold cavity and force it into the desired shape over a female mold.

In the ‘drapeforming’ thermoforming process plastic sheet is draped over a mold. A pressure-box closes on the sheet, and a vacuum is drawn between the mold and the sheet to remove trapped air and pull the sheet into or onto the mold along. Pressurized air can be used from the other side of the sheet to increase the net pressure forcing the sheet onto the mold, allowing more detailed shapes to be conformed to. To remove the mold, it is allowed to cool and a burst of air pressure is actuated from the vacuum side of the mold once the pressure box opens.

A variety of thermoplastic materials can be used in this process, including the following: ASA (Acrylonitrile\Styrene\Acrylate Copolymer), Korad film & Acrylic, HIPS—High-Impact Poly Styrene, ABS—Acrylonitrile Butadiene Styrene, HMW-HDPE—High Molecular Weight-High Density Poly Ethylene, PP—Poly Propylene, TPO—Thermo Plastic Olefin, TPU—Thermo Plastic Urethane, PVC—Poly Vinyl Chloride, PETG—Poly Ethylene Terephthalate (high-impact, co-polyester), PC—Poly Carbonate/Lexan Acrylic (PMMA), Acrylonitrile Butadiene Styrene (ABS), Cellulose Acetate Low Density Polyethylene (LDPE), High Density Polyethylene (HDPE), and Polystyrene (PS).

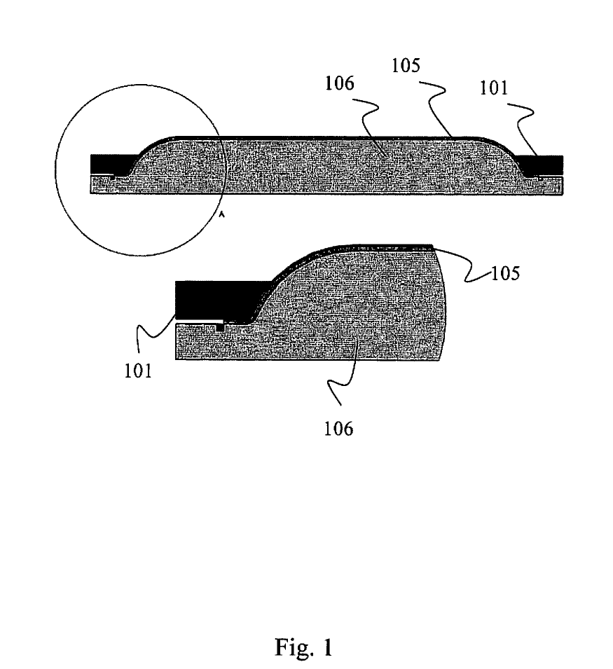

FIG. 1 shows a side view of the usual parts used in the vacuum thermoforming process. A plastic sheet 105 is draped over a bold. The mold 106 is used to force the parts to be formed into the desired shape. A supporting frame 101 is then placed around the plastic, forcing the plastic into contact with the mold around its periphery and sealing the vacuum against the mold. The frame 101 may usefully be held against the mold by means of clamps, springs, bolts or other reversible attachment means.

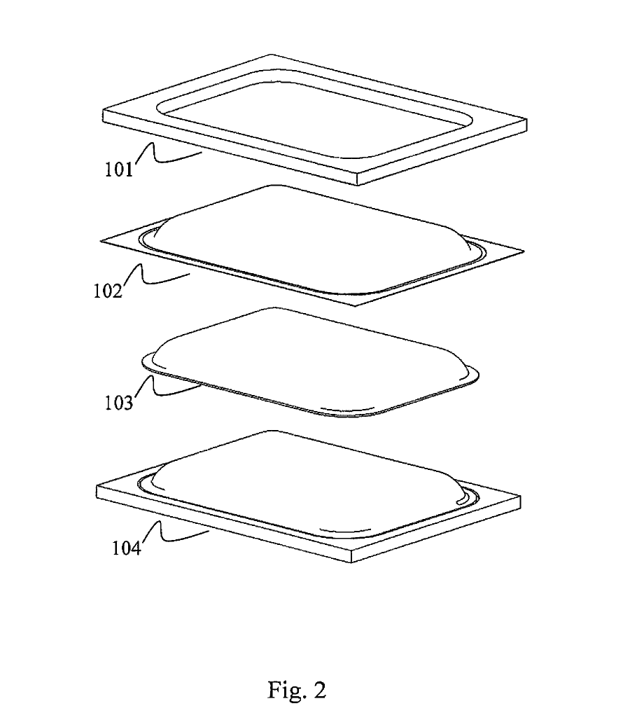

In light of this background we now present the invention. The invention consists of a unique approach to thermoforming/vacuum forming of leather and plastic products. FIG. 2 shows an isometric view of the parts involved. A supporting frame 101 is used to force the parts to be formed against the vacuum plate 104. The part to be formed 102, which may for instance be flexible leather fabric, is placed upon a plastic form 103 and these are in turn placed upon the plate 104. The supporting frame as mentioned is then placed upon the plate as well, forcing the parts into contact and sealing the vacuum against vacuum plate 104. The frame 101 may usefully be held against the vacuum plate 104 by means of clamps, springs, bolts or other reversible attachment means.

The plastic form 103 may itself be thermoformed by use of a rigid mold made of wood, metal, plastic or any other suitable material.

Said rigid mold that was used to create the plastic form 103 may be re-used in the leather forming steps.

By means of glue, epoxy or other adhesive, the leather and plastic parts 102, 103 are joined either during the forming process or afterwards. This allows one to produce a two layer bonded object of leather and plastic having unique properties of strength (e.g. that of ABS plastic) and appearance (e.g. that of fine leather).

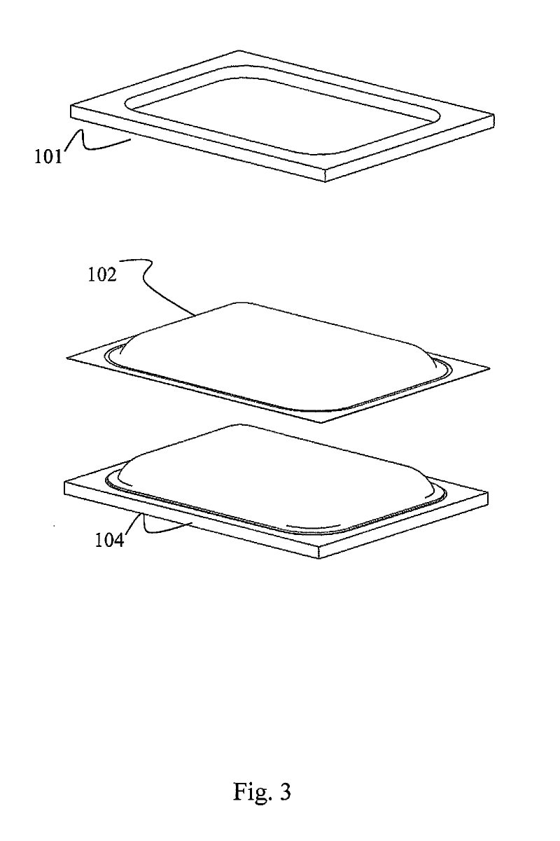

FIG. 3 shows a second stage of the process where the leather 102 has already been placed over the plastic (not visible).

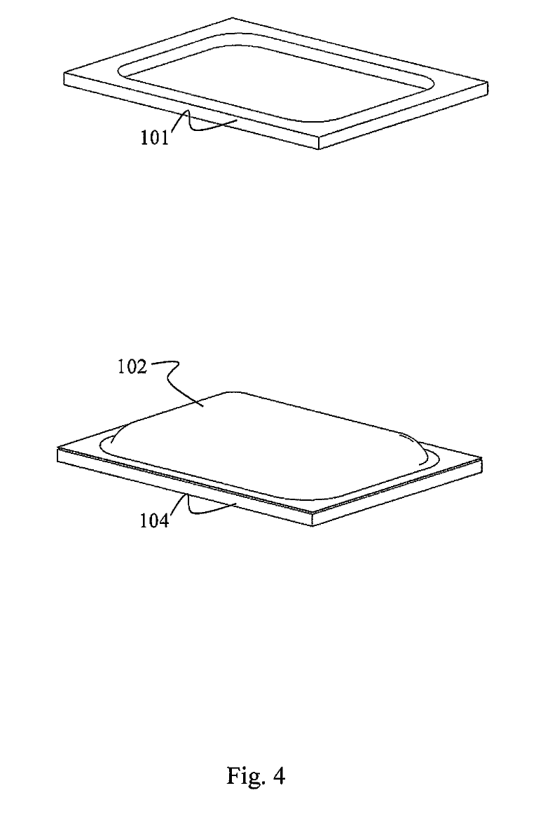

FIG. 4 shows a further stage wherein the leather and plastic sandwich 102 (plastic not visible) are placed on the vacuum plate 104.

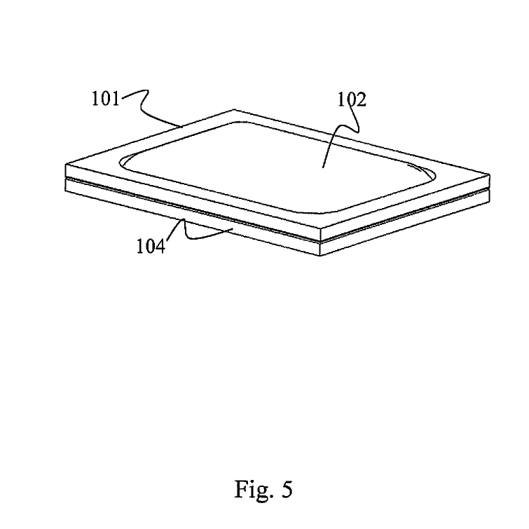

FIG. 5 shows the next step in the process wherein the top supporting frame 101 is placed over the leather 102, sealing it against the vacuum plate 104 and allowing a vacuum to be formed. As mentioned above the frame 101 may usefully be held against the vacuum plate 104 by means of clamps, springs, bolts or other reversible attachment means.

As will be appreciated by one skilled in the art the leather in this method is basically playing the role that plastic does in a standard thermoforming process. Thus it is critical to provide the leather with a degree of ‘reversible flexibility’; that is to say the leather must be flexible during the forming process and yet be made rigid afterwards; in the case of plastic this is accomplished by heating during forming and cooling thereafter. in the case of leather, the leather may be softened by any number of techniques such as soaking it in warm water for a period of a day or the like. As the water is absorbed into the leather it tends to soften it. During or after forming, the water is withdrawn (for instance simply by allowing the vacuum to gradually withdraw all the water in the leather, or by placing the article in a desiccant chamber after forming, or the like).

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A leather-plastic sandwich article comprising layers of leather 102 and plastic 103 rigidly bonded and formed into a desired shape.

2. The leather-plastic sandwich article of claim 1 produced by a leather vacuum-forming technique comprising steps of:
a. softening a largely planar piece of leather 102;
b. placing said leather over a rigid plastic form 103;
c. placing said form upon a vacuum backing plate 104;
d. placing a framework 101 around the periphery of said leather 102;
e. drawing a vacuum between said leather 102 and said plate 104;
f. removing said leather 102 and plastic form 103 from said vacuum plate 104;
g. bonding said plastic 103 to said leather 102.

3. The sandwich article of claim 2 wherein said leather is softened by means selected from the group consisting of: soaking in warm water; chemical softening treatment; mechanical softening treatment.

4. The sandwich article of claim 2 wherein said leather is bonded to said plastic form 103 by means of: epoxy; cyanoacrylate, collagen based adhesive, plant-based glues, polystyrene cement, synthetic monomer glues, synthetic polymer glues, rubber cement, silicones.

5. The sandwich article of claim 2 wherein said step of bonding said plastic to said leather is accomplished by placing glue between said plastic form 103 and said leather 104 before drawing said vacuum.

6. The sandwich article of claim 2 wherein said plastic form 103 is itself formed by means of vacuum forming techniques.

7. The sandwich article of claim 6 wherein said plastic form comprises two plastic outer layers and a foam inner layer.

8. The sandwich article of claim 7 wherein said plastic form is produced by filling an interstitial space between two said plastic outer layers with expanding urethane foam.

9. A method for producing leather-plastic sandwich articles comprising steps of
a. softening a largely planar piece of leather 102;
b. placing said leather over a rigid plastic form 103;
c. placing said form upon a vacuum backing plate 104;
d. placing a framework 101 around the periphery of said leather 102;
e. drawing a vacuum between said leather 102 and said plate 104;
f. removing said leather 102 and plastic form 103 from said vacuum plate 104;
g. bonding said plastic 103 to said leather 102.

10. The method of claim 9 wherein said leather is softened by means selected from the group consisting of: soaking in warm water; chemical softening treatment; mechanical softening treatment.

11. The method of claim 9 wherein said leather is bonded to said plastic form 103 by means of: epoxy; cyanoacrylate, collagen based adhesive, plant-based glues, polystyrene cement, synthetic monomer glues, synthetic polymer glues, rubber cement, silicones.

12. The method of claim 9 wherein said step of bonding said plastic to said leather is accomplished by placing glue between said plastic form 103 and said leather 104 before drawing said vacuum.

13. The method of claim 9 wherein said plastic form 103 is itself formed by means of vacuum forming techniques.

14. The method of claim 13 wherein said plastic form comprises two plastic outer layers and a foam inner layer.

15. The method of claim 14 wherein said plastic form is produced by tilling an interstitial space between two said plastic outer layers with expanding urethane foam.

16. The sandwich article of claim 2 wherein the plastic form 103 and the leather are formed using identically shaped molds.

17. The method of claim 9 wherein the plastic and the leather are formed using identically shaped molds.
